(19) United States
(12) Patent Application Publication
(10) Pub. No.: US 2005/0286735 A1
(43) Pub. Date: Dec. 29, 2005

(54) Speaker grill

(76) Inventor: Kazuhiko Ikeuchi, Takatsuki (JP)

Correspondence Address: WENDEROTH, LIND & PONACK, L.L.P., 2033 K STREET N. W., SUITE 800, WASHINGTON, DC, 20006-1021, US

(21) Appl. No.: 10/524,593

(22) PCT Filed: Aug. 6, 2004
(86) PCT No.: PCT/JP04/11632

§ 371 Date: Feb. 15, 2005

(30) Foreign Application Priority Data
Aug. 7, 2003 (JP) 2003-288717

(51) Int. Cl. H04R 1/02

(52) U.S. Cl. 381/391

(57) ABSTRACT

A speaker grille disposed in front of a speaker having a diaphragm and reproducing the sounds of 1 kHz and higher. The speaker grille is provided with a sound opening which includes a line that opposes to a region extending from the edge portion of a diaphragm to the fixing portion on the outer circumference of the diaphragm of speaker. The speaker grille offers superior sound characteristics, at the same time a sufficient mechanical strength either.

### TECHNICAL FIELD

The present invention relates to a speaker grille attached to a cabinet, etc. for combination with a speaker.

### BACKGROUND ART

A speaker grille is designed so that it has a sufficient mechanical strength needed for protecting a speaker from damage, at the same time it has to provide a speaker with an opening that is large enough not to ill-affect the quality of reproduced sounds. For those speakers whose diaphragm areas are small, among other speaker types, new structures have been proposed for their speaker grilles in order to reduce an area which blocks diaphragm region to a minimum, while securing a sufficient mechanical strength. Japanese Patent Unexamined Publication No. 2003-37883 discloses a conventional speaker grille 91 as shown in FIG. 27; which speaker grille is disposed in front of speaker 92, and provided with sound openings 93 whose open rates are uneven.

Speaker grilles require quite a high open rate for not retarding sound vibration of speakers. The main sound openings are disposed in an area corresponding to the central region of a diaphragm, where the sound pressure level is high. Describing more practically, the sum area of sound openings has to be at least 60%, if the characteristics have to be kept within approximately −6 dB for the sounds of 5 kHz and higher. The smaller the speaker size is, the higher the open rate is required for the speaker grille.

FIG. 28 is a sound characteristics chart of a speaker combined with a speaker grille whose open rate is as low as 28%. In the chart, the solid line represents sound characteristics 95 with no speaker grille attached, while the dotted line represents sound characteristics 96 with the speaker grille attached. The sound pressure level is lower in the vicinity of 5 kHz and of 10 kHz with sound characteristics 96 shown in dotted line, as compared with characteristics 95. On the other hand, sound characteristics 96 exhibit higher sound pressure level in the vicinity of 3 kHz; which is due to resonance. Thus, design in the sound openings of a speaker grille gives significant influence to the characteristics of sounds of a speaker combined with the speaker grille.

The intrinsic task of a speaker grille is to protect a speaker from damage, so it has to have a certain mechanical strength. Therefore, there is a limitation to making the size of sound opening larger. The speaker grille as shown in FIG. 27 secures a certain open rate by providing rectangular sound openings in the area opposing to diaphragm edge, in addition to the area opposing to the central part of diaphragm. This configuration, however, requires a certain thickness for ensuring a required mechanical strength. This means that it is not suitable for use with the small-size speakers, among other types of speakers.

### DISCLOSURE OF INVENTION

A speaker grille in the present invention is disposed in front of a diaphragm speaker which reproduces the sounds of 1 kHz and higher. The speaker grille includes a line which opposes to a region from the edge portion of a speaker diaphragm to the fixing portion on the outer circumference of the diaphragm. The speaker grille provides superior sound characteristics, at the same time a sufficient mechanical strength either.

### BRIEF DESCRIPTION OF THE DRAWINGS

FIG. 1A is a perspective view showing a speaker grille in accordance with a first exemplary embodiment of the present invention, and a speaker connected with the speaker grille.

FIG. 1B is a cross sectional view showing a key part of the speaker shown in FIG. 1A.

FIG. 1C is a cross sectional view showing a key part of another speaker coupled with the speaker grille of FIG. 1A.

FIG. 2 shows sound characteristics exhibited by a combination of the speaker grille and the speaker of FIG. 1A.

FIG. 3 shows sound characteristics exhibited by a combination of a speaker grille having a sound opening at the center and the speaker of FIG. 1A.

FIG. 4 shows sound characteristics exhibited by the speaker of FIG. 1A which is blocked to be half in the direction of the major axis.

FIG. 5 shows sound characteristics exhibited by the speaker of FIG. 1A which is blocked to be half in the direction of the minor axis.

FIG. 6 shows sound characteristics exhibited by a combination of the speaker grille and the speaker of FIG. 1A.

FIGS. 7 through 9 show sound characteristics exhibited by the speaker grille of FIG. 1A, with different open rates.

FIG. 10 is a perspective view showing a speaker grille in accordance with a second exemplary embodiment of the present invention and a speaker connected with the speaker grille.

FIG. 11 shows sound characteristics exhibited by a combination of the speaker grille and the speaker of FIG. 10.

FIG. 12 shows sound characteristics exhibited by a combination of a speaker grille having a sound opening at the center and the speaker of FIG. 10.

FIG. 13 is a perspective view showing a speaker grille in accordance with a third exemplary embodiment of the present-invention and a speaker connected with the speaker grille.

FIG. 14 shows sound characteristics of the speaker of FIG. 13 which is blocked to be half in the direction of major axis.

FIG. 15 shows sound characteristics of the speaker of FIG. 13 which is blocked to be half in the direction of minor axis.

FIG 16. shows sound characteristics exhibited by a combination of the speaker grille and the speaker of FIG. 13.

FIGS. 17 through 19 show sound characteristics exhibited by the speaker grille of FIG. 13 with different open rates.

FIGS. 20 through 22 show the structures of other speaker grilles in the third embodiment of the present invention.

FIG. 23 shows sound characteristics exhibited by a combination of the speaker grille in FIG. 20 and the speaker in FIG. 13.

FIG. 24 shows sound characteristics exhibited by a combination of the speaker grille in FIG. 21 and the speaker in FIG. 13.

FIG. 25 shows sound characteristics exhibited by a combination of the speaker grille in FIG. 22 and the speaker in FIG. 13.

FIG. 26 is a cross sectional view showing a state of an exemplary combination where the speaker in FIG. 13 is connected with either one of the speaker grilles in FIGS. 20 through 22.

FIG. 27 shows a structure of a conventional speaker grille.

FIG. 28 shows sound characteristics exhibited by a conventional configuration in which the open area is reduced.

### DETAILED DESCRIPTION OF PREFERRED EMBODIEMNTS

Exemplary embodiments of the present invention are described in the following with reference to the drawings. In each of the following embodiments, those portions having the identical structures as those of preceding embodiments are represented by using the identical symbols, and detailed description on such portion is sometimes eliminated. It is to be noted that the descriptions of embodiments are just exemplary; they should not be interpreted to limit scope of the invention.

### First Exemplary Embodiment

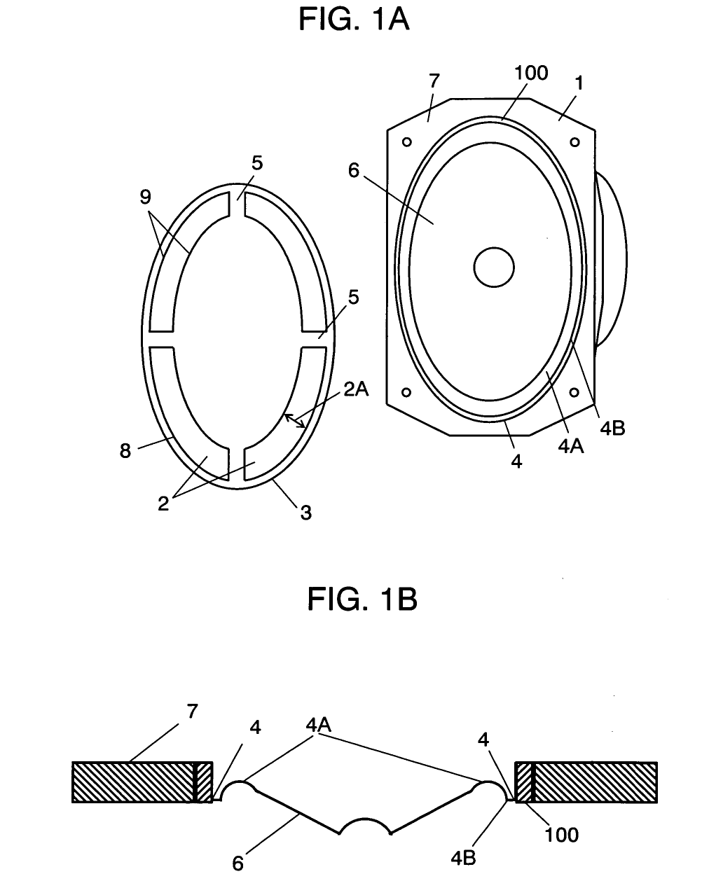

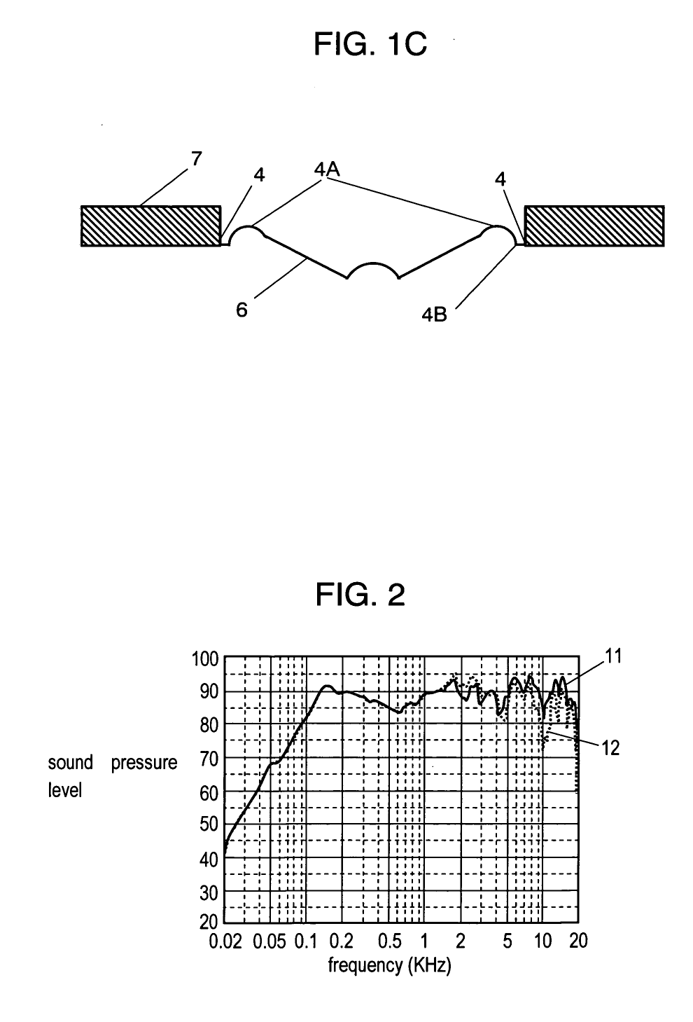

FIG. 1A is a perspective view showing a speaker grille in accordance with a first exemplary embodiment of the present invention and a speaker connected with the speaker grille. FIG. 1B is a cross sectional view of the speaker shown in FIG. 1A. Speaker 1 is provided with diaphragm 6 which forms an oval vibration plane with the major axis of 12 cm and the minor axis of 8 cm. Diaphragm 6 is fixed at the outer circumference to frame 7 and gasket 100. Speaker grille 3 is disposed in front of speaker 1, and fixed to frame 7 which covers diaphragm 6. Speaker grille 3 may be made of an acrylic resin or the like resin, aluminum or other metal material, using a cutting process or a die-molding process. Speaker grille 3 has a thickness of about 0.1-10 mm. Speaker grille 3 may be formed as an integral part of a cabinet for television receiver, radio receiver or the like audio apparatus; there is no specific limitation to the material used, it may be provided by cutting a wooden material, for example.

Speaker grille 3 is provided with sound openings 2, which is divided by reinforcement rib 5 disposed for ensuring a certain mechanical strength over the entire speaker grille 3. Each of sound openings 2 includes line 8 that is opposing to a region from edge portion 4A of diaphragm 6 to fixing portion 4 on the outer circumference of diaphragm 6. Each sound opening 2 has arc-curved portion 9 that is in parallel with fixing portion 4 on the outer circumference of diaphragm 6. By forming sound openings 2 in the above-described manner so that they include arc-curved portions 9 proceeding along fixing portion 4 on the outer circumference, sound openings 2 are provided so that it contains, to the maximum extent, the area opposing to edge portion 4A. In the example shown in FIG. 1A, curved portion 8 is shown in coincidence with fixing portion 4; so, the line opposing to a region from edge portion 4A to fixing portion 4 on the outer circumference of diaphragm 6 can be explicitly recognized as line 8. However, the perforated area of sound opening 2 may include such line which we sometimes fail to explicitly recognize.

Here, the terminology “fixing portion 4 on the outer circumference of diaphragm 6” signifies the inner circumference line of gasket 100, the gasket being provided at the outer circumference of edge portion 4A. In a case where the speaker is not provided with a gasket as shown in FIG. 1C, the terminology indicates the inner circumferential line of frame 7 locating at the outside of edge portion 4A. In any case, fixing portion 4 signifies the outermost circumference of a vibration plane which vibrates when speaker 1 generates sounds. However, since the main vibration part is at a place inner than the outer circumference of edge portion 4A, it is preferred that sound opening 2 include a line that opposes to outer circumference 4B of edge portion 4A.

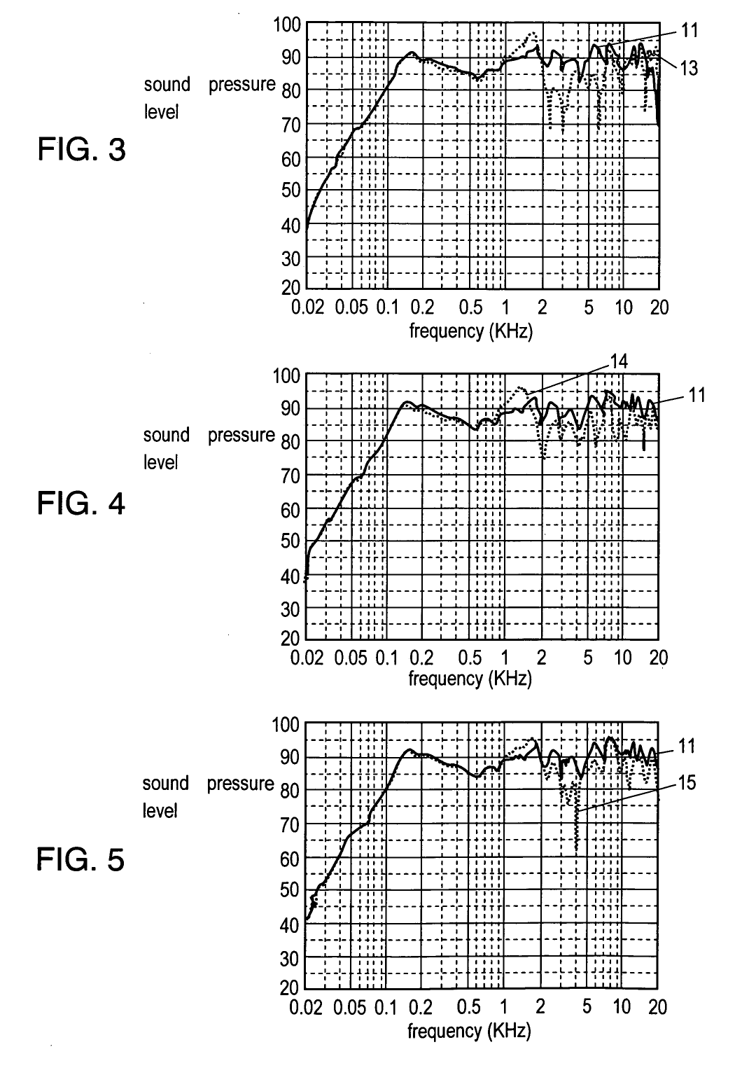

Sound characteristics exhibited by a combination of the above-configured speaker grille 3 and speaker 1 are shown in FIG. 2. Meanwhile, sound characteristics exhibited by a combination of a speaker grille having a round opening of the same square measure as that of sum of sound openings 2 at the center to be concentric with diaphragm 6 and speaker 1 are shown in FIG. 3. In either of the above combinations, there is no serious difference between characteristics curve 11 representing the sounds without a speaker grille and characteristics curves 12, 13 representing the sounds with the speaker grilles attached, in so far as the sound region lower than 1 kHz is concerned. Characteristics curve 13, however, shows resonance in the vicinity of 1-2 kHz and in the vicinity of 4 kHz, and, as a reaction to it, the harmonic characteristics deteriorate. On the other hand, characteristics curve 12 indicates a significant improvement with respect to the characteristics deterioration. These teach us that even if sum of the square measure of the sound openings is equal, the speaker grille generates resonance when the area opposing to edge portion 4A is blocked; furthermore, the characteristics deteriorate in the high sound region of 9 kHz or higher. Therefore, it is preferred that a speaker grille be designed into such a structure as shown in FIG. 1A. Thus, speaker grille 3 brings about an advantage for those speakers which reproduce the sounds of 1 kHz and higher.

Next, the sound characteristics are compared using speaker grilles each having a 50% open rate; between a combination with speaker 1 blocked to be half in the direction of the major axis and speaker 1 blocked to be half in the direction of the minor axis. The respective sound characteristics are shown with characteristics curve 14 in FIG. 4 and characteristics curve 15 in FIG. 5. Here, the terminology “open rate” stands for a proportion of effective open area provided by sound openings 2 against a projected area of diaphragm 6. In a case where part of sound openings 2 coincide with fixing portion 4, as shown in FIG. 1A, or a case where sound openings 2 are disposed to be inner than fixing portion 4, the effective open area is sum of the square measure of sound openings 2 itself. On the other hand, in a case where any of sound openings 2 include the portion that is opposing to fixing portion 4, the effective open area is sum of the area of sound openings 2 minus a square measure blocked by gasket 100 or frame 7.

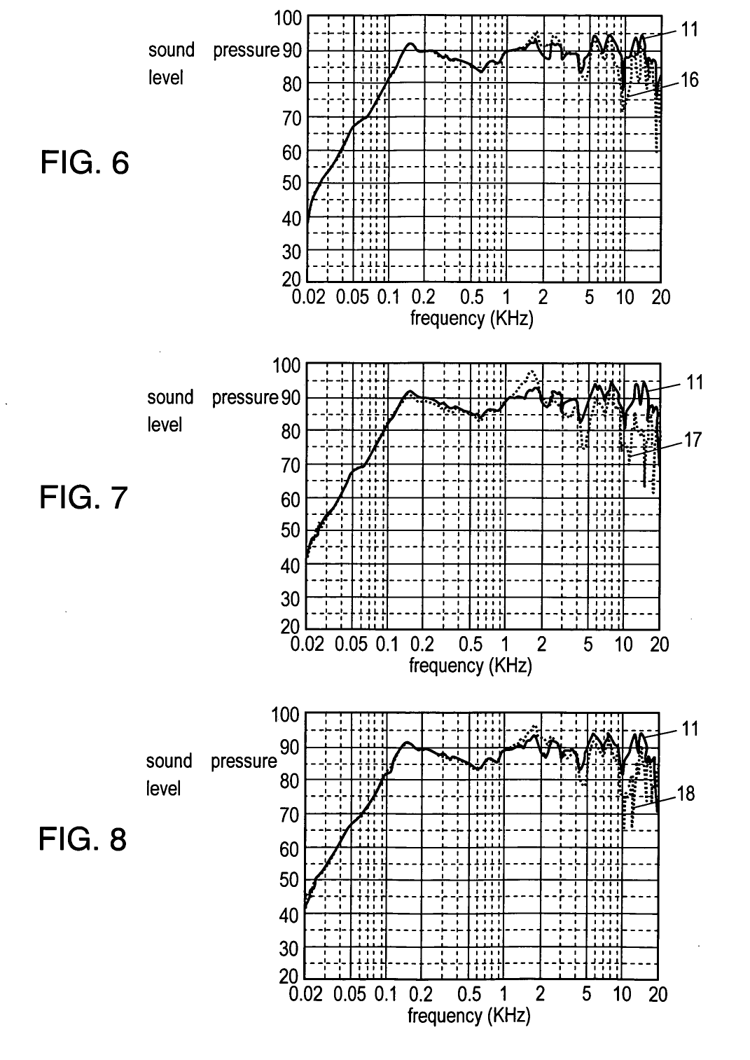

The sound characteristics exhibited by a combination of speaker grille 3 having the same open rate as described above in the same pattern as shown in FIG. 1A and speaker 1 are shown with characteristics curve 16 in FIG. 6. Both FIG. 4 and FIG. 5 exhibit resonance; this is because, as already described earlier, a substantial part of an area opposing to edge portion 4A is blocked. On the other hand, characteristics curve 16 exhibits superior characteristics with the resonance suppressed, as compared with characteristics curves 14 and 15.

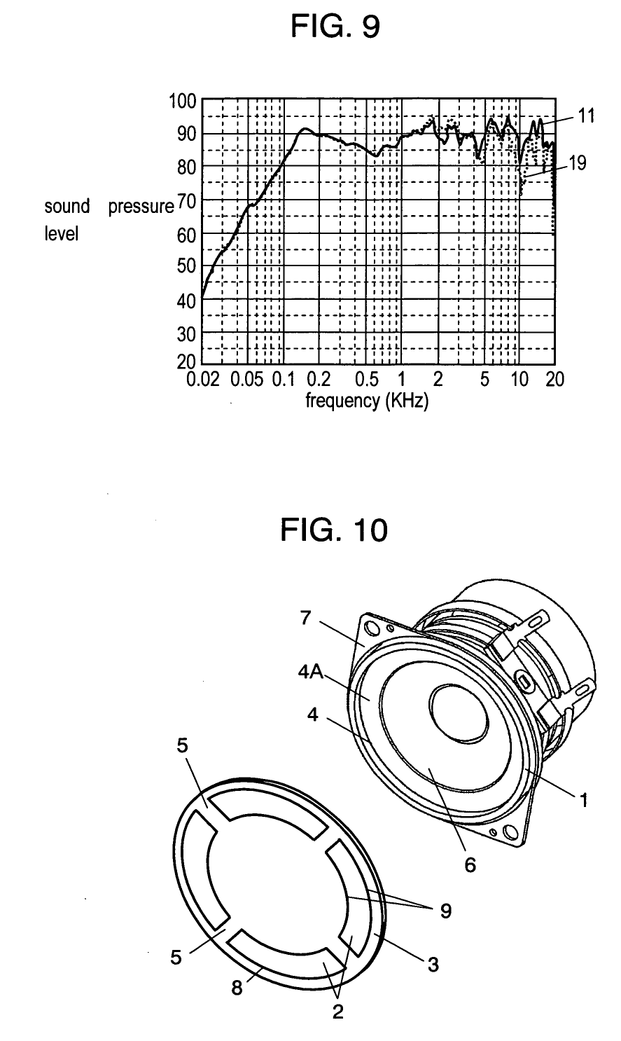

Now in the following, description is made on the change of sound characteristics caused as the result of varied open rate, which variation in the open rate is devised by changing width 2A of sound openings 2. Characteristics curve 17 in FIG. 7 represents the sound characteristics when width 2A is 5 mm, whereas characteristics curve 18 in FIG. 8 represents those when width 2A is 10 mm. The greater the width 2A is, the better the sound characteristics are. Characteristics curve 19 in FIG. 9 which represents an example where width 2A is 15 mm is substantially identical to curve 16 in FIG. 6; deterioration in the characteristics is suppressed to be approximately −3 dB in the sound region of 1 kHz or higher. The open rate of the example is 31%. Namely, the open rate should preferably be at least 31%. From the view point of mechanical strength of speaker grille 3, the open rate should preferably be lower than 60%.

### Second Exemplary Embodiment

FIG. 10 is a perspective view showing a speaker grille in accordance with a second exemplary embodiment of the present invention and a speaker connected with the speaker grille. Speaker 1 is provided with diaphragm 6 which forms a round vibration plane of 8 cm diameter. The rest parts of the structure remains the same as those in the first embodiment.

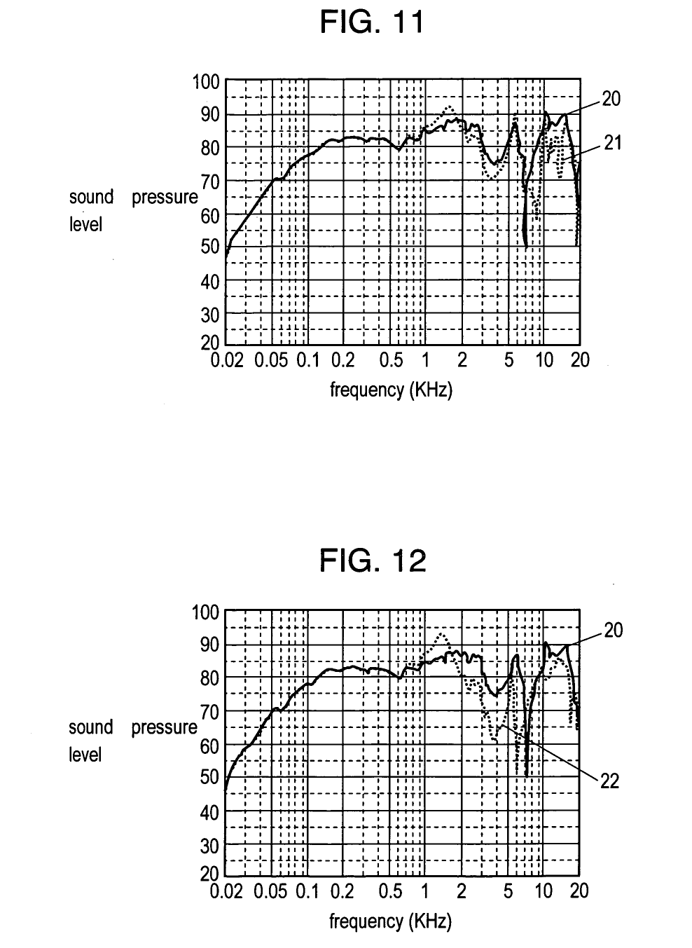

Sound characteristics exhibited by a combination of the above-configured speaker grille 3 and speaker 1 are shown in FIG. 11. Meanwhile, FIG. 12 shows sound characteristics exhibited by a combination of a speaker grille which is provided with, instead of sound openings 2, a round opening of the same square measure as sum of sound openings 2 disposed to be concentric with the center of diaphragm 6, and speaker 1. In either of the above combinations, there is no serious difference between characteristics curve 20 representing the sounds without a speaker grille and characteristics curves 21, 22 representing the sounds with the speaker grilles attached, in so far as the sound region lower than 1 kHz is concerned. Characteristics curve 22, however, shows resonance in the vicinity of 1-2 kHz and in the vicinity of 5 kHz; and, as a reaction to it, the harmonic characteristics deteriorate. On the other hand, characteristics curve 21 indicates a significant improvement with respect to the characteristics deterioration. Thus, even if sum of the square measure of the sound openings is equal, the speaker grille generates resonance and results in a substantial deviation from a speaker's own sound characteristics when the area opposing to edge portion 4A is blocked. Therefore, it is preferred that speaker grille be designed into such a structure as shown in FIG. 10. Preferred open rate in the present embodiment is at least 31% and lower than 60%, which being the same as that described in the first embodiment. Detailed description on which is eliminated here.

### Third Exemplary Embodiment

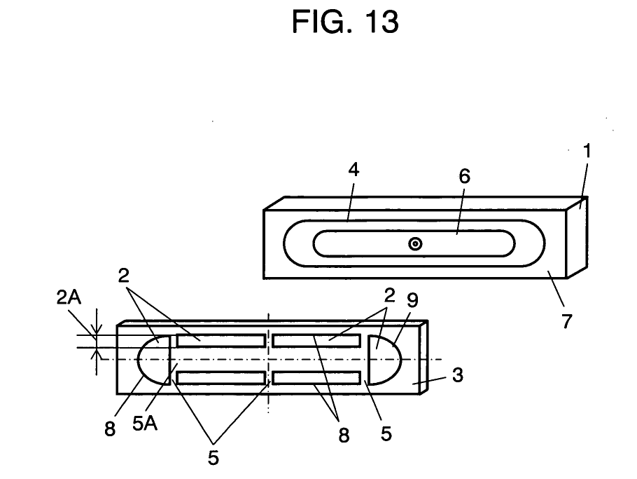

FIG. 13 is a perspective view showing a speaker grille in accordance with a third exemplary embodiment of the present invention and a speaker connected with the speaker grille. Speaker 1 measures 73 mm in the longer side and 17 mm in the shorter side, which is provided with diaphragm 6 of oblong vibration plane. Diaphragm 6, made of a polyimide or the like resin film, is fixed at the circumference with frame 7. Speaker grille 3 is disposed in front of speaker 1, and fixed to frame 7 covering diaphragm 6.

Speaker grille 3 is provided with sound openings 2, which are divided by reinforcement ribs 5 and block portion 5A; reinforcement ribs 5 are disposed for ensuring a certain mechanical strength over the whole speaker grille 3, and block portion 5A blocks the central region of vibration plane. Block portion 5A protects the central area of diaphragm 6. Each of sound openings 2 includes line 8 that is opposing to a region from edge portion 4A of diaphragm 6 to fixing portion 4 on the outer circumference of diaphragm 6. Sound openings 2 at both ends have arc-curved portion 9 which are in parallel with fixing portion 4 on the outer circumference of diaphragm 6. By forming sound openings 2 in the above layout where it includes curved portion 9 along fixing portion 4 at the outer circumference, sound openings 2 can be provided to contain, to the maximum extent, the area opposing to edge portion 4A.

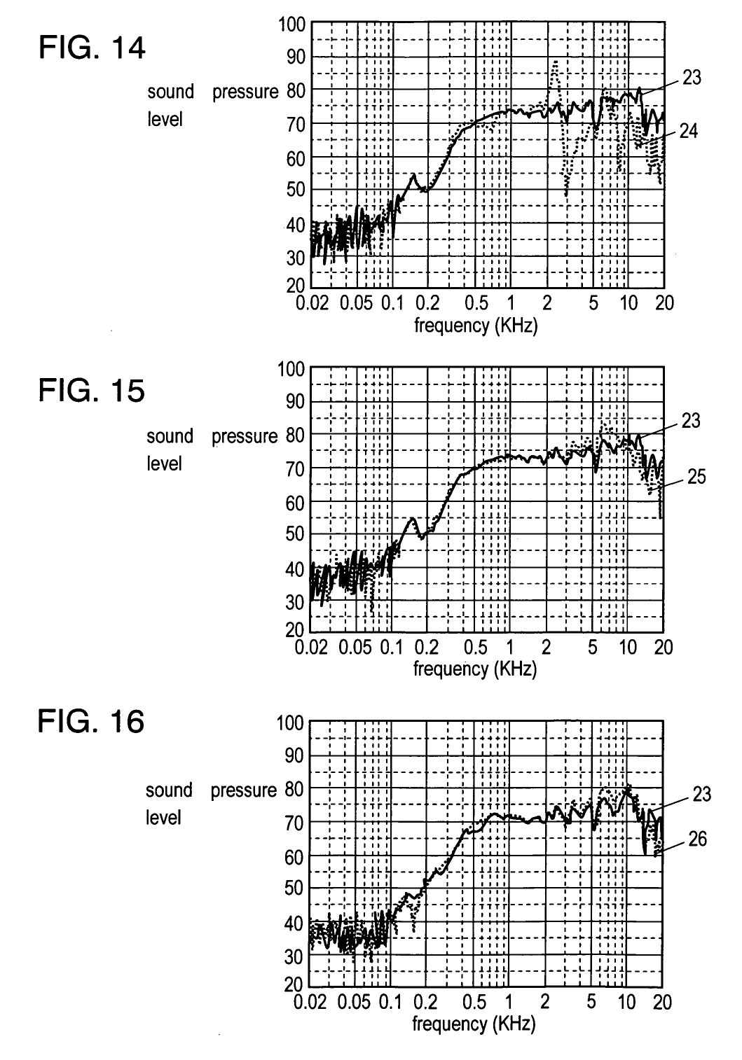

Sound characteristics exhibited by a combination of the above-configured speaker grille 3 and speaker 1 are shown with characteristics curve 26 in FIG. 16. The open rate against the cross sectional area of vibration plane is 47%, in the present case. Meanwhile, sound characteristics exhibited by a combination with a speaker grille of the same open rate blocking half of speaker 1 in the direction of the longer side are shown with characteristics curve 24 in FIG. 14, and those with a speaker grille blocking half of speaker 1 in the direction of the shorter side are shown with characteristics curve 25 in FIG. 15. In either of the above charts, characteristics curve 23 represents those without speaker grille 3.

Characteristics curve 24 shows resonance. This is due to the large blocking area opposing edge portion 4A. On the other hand, the resonance is suppressed in characteristics curves 25 and 26. The reason why the resonance is suppressed in curve 25 seems to be in the fact that the size of speaker 1 in the present embodiment is smaller than the counterparts in the first and the second embodiments. In the sound region of 5 kHz-10 kHz, however, curve 26 exhibits a profile which is closer to curve 23 than that of curve 25; which means curve 26 is more favorable.

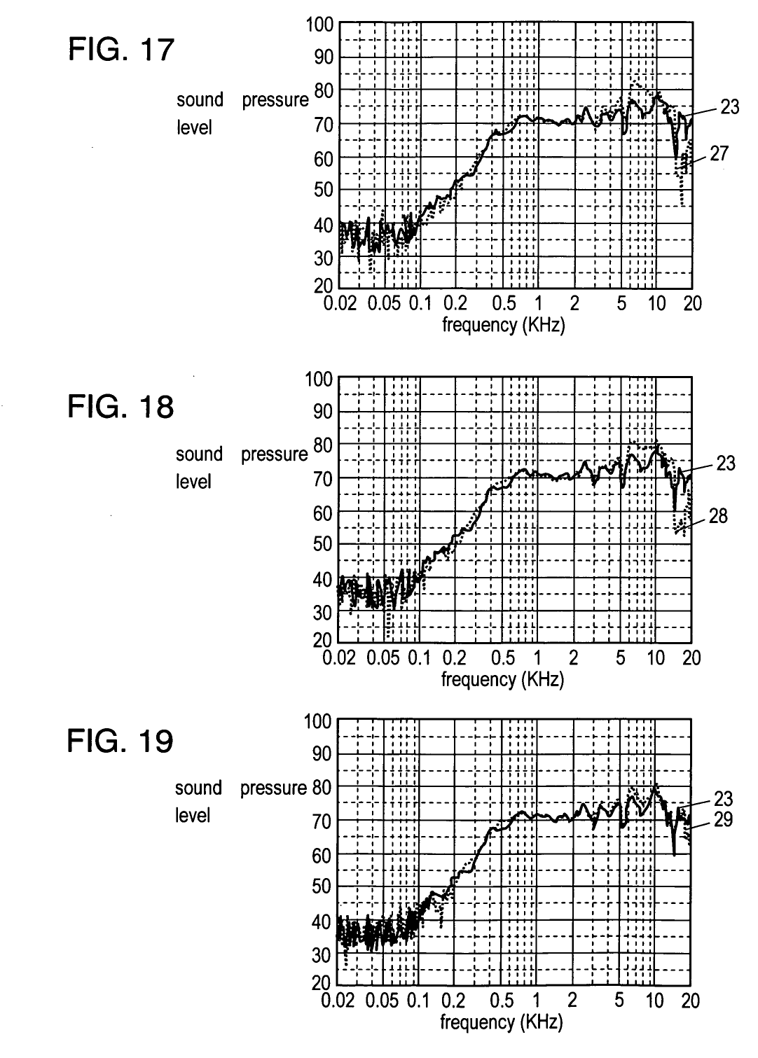

Next, change in the sound characteristics caused by varied open rate, devised by changing widths 2A, is described. Characteristics curve 27 in FIG. 17 exhibits the sound characteristics when width 2A is 2 mm, whereas characteristics curve 28 in FIG. 18 exhibits those when width 2A is 3 mm. As can be understood from the charts, the sound characteristics improve along with the increasing width 2A. Characteristics curve 26 in FIG. 16 represents the result where width 2A is 4 mm; the curve is substantially identical to curve 29 in FIG. 19, which represents the result where width 2A is 5 mm. In the above two curves, deterioration of the characteristics is suppressed to be approximately −3 dB in the sound region of 1 kHz or higher. The open rate in this case is 47%, as already described earlier. Namely, the open rate is preferably at least 47%. Whereas from the view point of ensuring a certain mechanical strength with speaker grille 3, the open rate is preferably lower than 60%.

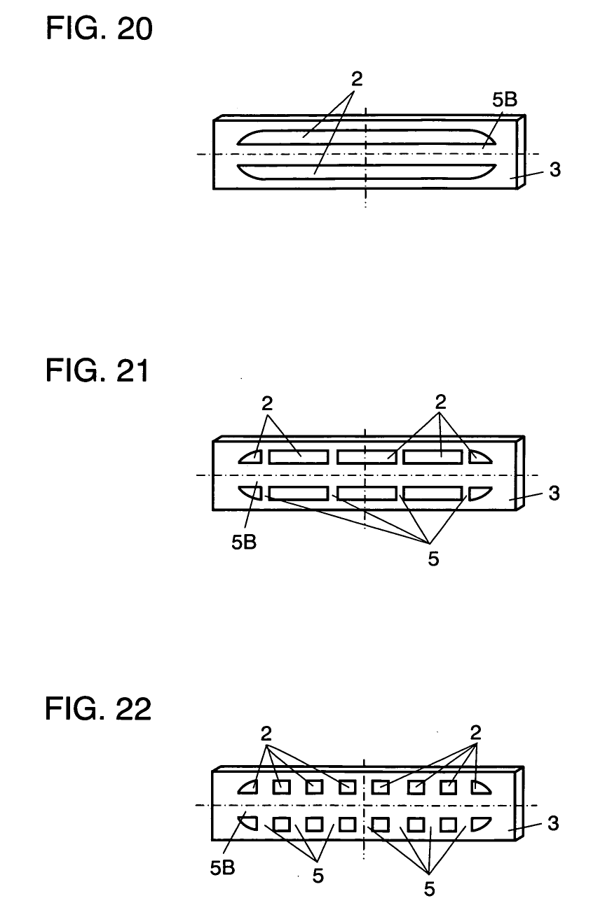

Now in the following, description is made on variations in the shape of speaker grille 3 connected to the so-called slim-type speaker 1 of FIG. 13. FIG. 20 shows a variation of speaker grille 3; sound openings 2 are provided only in the area corresponding to edge portion 4A, reinforcement rib 5B is provided in parallel with the longer sides of vibration plane and is located at the center in the direction of the shorter sides of vibration plane, so that it separates two sound openings 2 in the direction of the shorter sides of vibration plane. Namely, one reinforcement rib 5B is formed laterally with an approximate width of 6 mm expanding equally from the central line towards up and down.

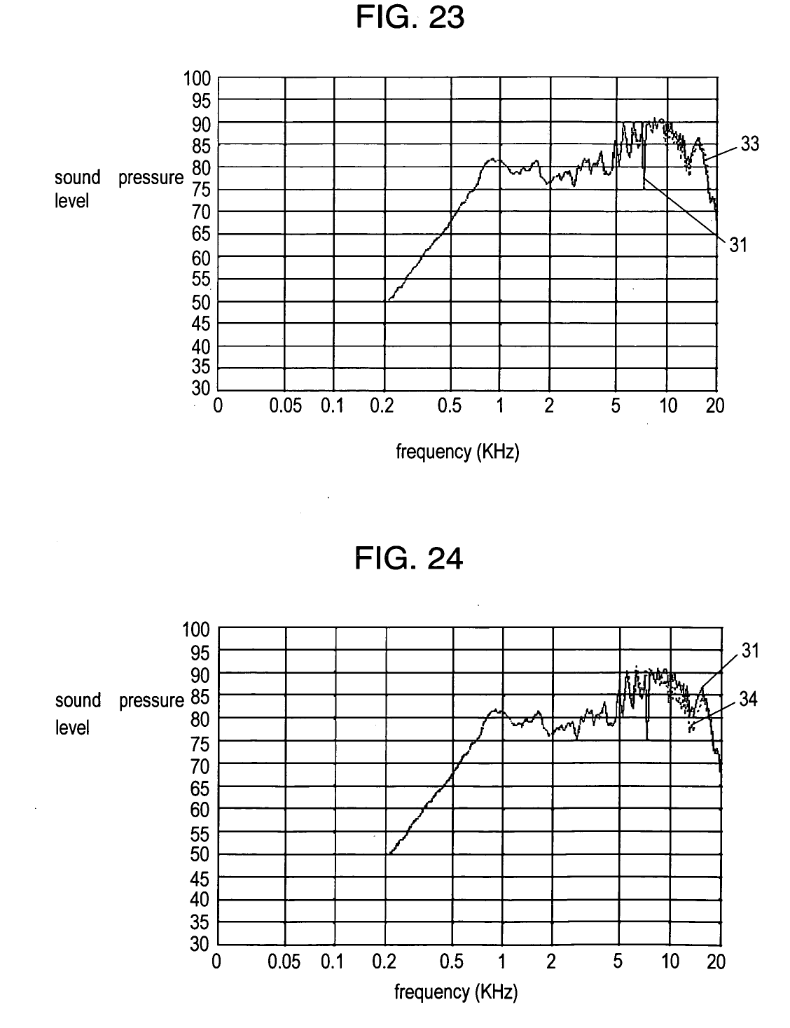

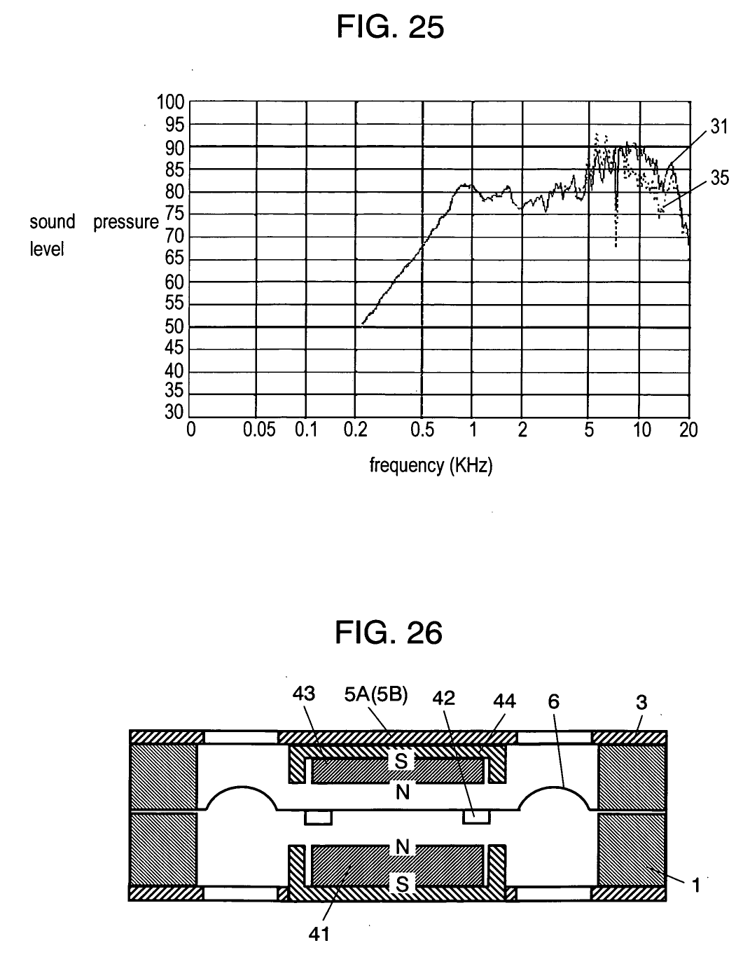

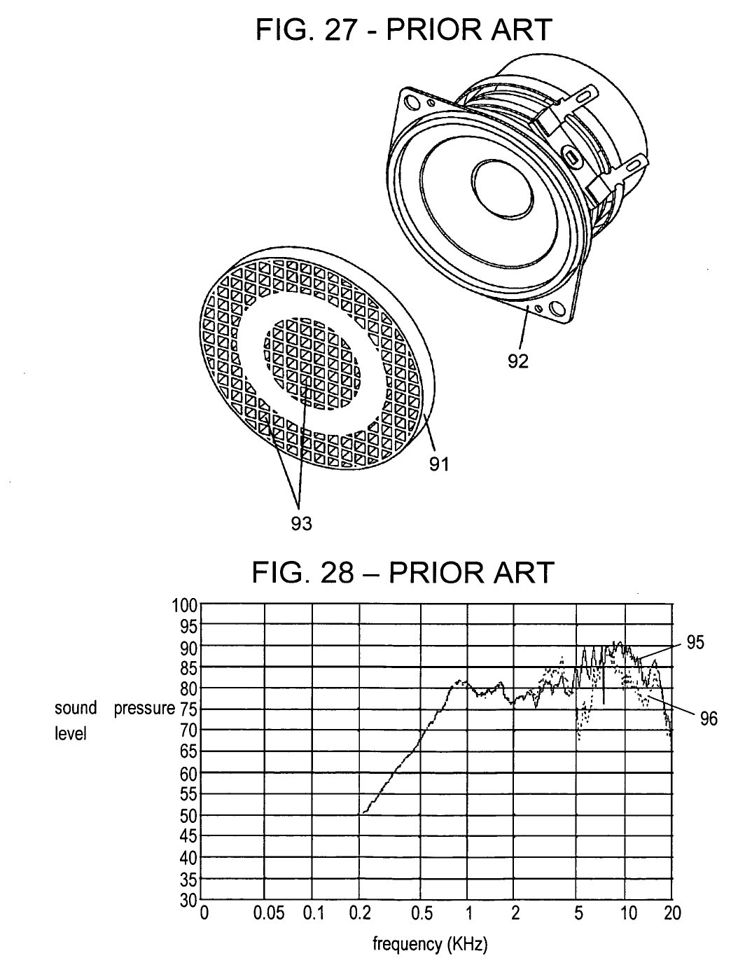

FIG. 21 and FIG. 22, respectively, show other exemplary variations of speaker grille 3; they are provided with a plurality of reinforcement ribs 5 disposed in parallel with the shorter sides of vibration plane for further splitting the two sound openings, further to the configuration shown in FIG. 20. Namely, rib 5B is formed laterally with an approximate width of 6 mm expanding equally from the central line towards up and down. In addition, sound openings 2 having an approximate width of 14 mm and ribs 5 having an approximate width of 2 mm are alternately disposed in the right-left direction with equal orientation from the central line for as long as approximately 50 mm in the lateral length and the sets of the openings and ribs are disposed in a longitudinal direction, in FIG. 21. In FIG. 22, with equal orientation from the central line in the lateral direction, sound openings 2 having an approximate width of 4 mm and ribs 5 having an approximate width of 4 mm are disposed alternately with equal orientation from the central line in the lateral direction. The open rate in FIG. 20, FIG. 21 and FIG. 22 are 48%, 28% and 22%, respectively. Sound characteristics of these speaker grilles 3 connected with speaker 1 of FIG. 13 are shown in the respective charts shown in FIG. 23, FIG. 24 and FIG. 25. In each of the charts, solid line curve 31 represents the characteristics without a speaker net, while dotted line curves 33, 34 and 35 exhibit those with a speaker net.

In the combination corresponding to FIG. 23, open rate of 48% is secured against the aperture area of the speaker. Therefore, the characteristics curve 33 shows hardly any deviation from the original characteristics curve 31. In the combination corresponding to FIG. 24, the open rate is 28% against the aperture area of the speaker; therefore, the characteristics are inferior as compared to characteristics curve 33, but the characteristics deterioration is suppressed to be approximately −3 dB in the sound region of 8 kHz or higher. In the combination corresponding to FIG. 25, the open rate is 22% against the aperture area of the speaker; therefore, the characteristics are inferior compared to characteristics curve 33, but the characteristics deterioration is suppressed to be approximately −6 dB in the sound region 5 kHz or higher.

Furthermore, it is preferred to provide magnet 43 on speaker grille 3 at the surface facing to diaphragm 6, as illustrated in FIG. 26, a cross sectional view. Speaker 1 has flat voice coil 42 disposed on diaphragm 6 at the location opposing to magnet 41. Magnet 43 can be attached to block portion 5A or rib 5B. Further, yoke 44 may be provided in order to have magnetic flux of magnet 43 more concentrated.

Magnet 43 is disposed to oppose magnet 41 in a repulsive polarity arrangement. With such a configuration, direction of generated magnetic flux is orientated to be horizontal and the electric current traveling in coil 42 makes a perpendicular crossing with the magnetic flux. This enhances the magnetism efficiency.

Although sound openings 2 in each of the above embodiments are described in a shape that it is surrounded with an arc curve or a straight line, it is not the intension of the present invention to limit the shape of sound opening 2 as such. Sound openings 2 may be provided in whatever manner so far as they are formed in an area within the inside of line 8 and they include line 8; the line is facing the region extending from edge portion 4A of speaker 1 to fixing portion 4 on the outer circumference of diaphragm 6.

Although sound openings 2 in each of the above embodiments are described that they include a line opposing to fixing portion 4 on the outer circumference, it is not the intension of the present invention to limit it as such. For example, sound openings 2 may be provided in such a manner where they include a line which is opposing to the inner circumference of edge portion 4A and are formed to be inner than the line. With this configuration, the advantage of the present invention can be implemented to some extent. Especially with those speakers of large aperture diameter, even a sound opening provided in an area inner than the inner circumference of edge portion 4A can ensure satisfactory sound characteristics. With the speakers of small aperture diameter, however, deterioration in the sound characteristics is significant if there is no sound opening 2 in front of edge portion 4A. So, it is preferred to provide sound opening 2 in a manner that it includes a line which is facing a virtual line locating at least 3 mm inner from the outer circumference of edge portion 4A. The approximate distance of 3 mm can offer an advantage that is identical to that described in the embodiments of the present invention.

### INDUSTRIAL APPLICABILITY

A speaker grille of the present invention is disposed in front of a speaker having a diaphragm and reproducing the sounds of 1 kHz or higher. The speaker grille is provided with a sound opening which includes a line opposing to a region extending from the edge portion of the diaphragm to the fixing portion on the outer circumference of the diaphragm. The sound opening is provided only in an area inner than the line. The above-configured speaker grilles offer practical advantages when used as the sound aperture for acoustic apparatus which includes a speaker.

1. A speaker grille provided with a sound opening, the speaker grille being fixed at a fixing portion on the outer circumference and disposed in front of a speaker comprising a diaphragm including an edge portion, the speaker reproducing sounds of 1 kHz and higher; wherein
the speaker grille is provided with a reinforcement rib opposing to a central part of the speaker, and
the sound opening includes a line opposing to a region extending from the edge portion of the diaphragm to the fixing portion on the outer circumference.

2. The speaker grille of claim 1, wherein
the sound opening includes a line opposing to the outer circumference of the edge portion of the diaphragm.

3. The speaker grille of claim 1, wherein
the speaker is provided with one of a round vibration plane and an oval vibration plane, the sound opening includes an arc-shape curve in parallel with the fixing portion on the outer circumference.

4. The speaker grille of claim 1, wherein
the sound opening is one of a plurality of sound openings, the reinforcement rib has a portion for separating the sound openings.

5. The speaker grille of claim 1, wherein
the speaker is provided with one of a round vibration plane and an oval vibration plane, an effective open area of the sound opening is at least 31% and less than 60% of a projected area of the vibration plane.

6. The speaker grille of claim 1, wherein
the speaker is provided with a vibration plane of an oblong round shape, an effective open area of the sound opening is at least 22% and less than 60% of a projected area of the vibration plane.

7. The speaker grille of claim 6, wherein
the effective open area of the sound opening is at least 48% and less than 60% of the projected area of the vibration plane.

8. The speaker grille of claim 1, wherein
the speaker is provided with a vibration plane of an oblong round shape, the sound opening is one of a plurality of sound openings, the reinforcement rib has portions for separating the sound openings in a direction of a shorter side of the vibration plane.

9. The speaker grille of claim 8, further provided with a block portion for blocking a central portion of the vibration plane at the middle with respect to a longer side of the vibration plane.

10. The speaker grille of claim 9, further provided with a magnet on a surface of the block portion, the surface opposing to the vibration plane.

11. The speaker grille of claim 1, wherein
the speaker is provided with a vibration plane of an oblong round shape, the sound opening is one of two sound openings, the reinforcement rib has a first portion extending in a direction of a longer side of the vibration plane and disposed at the middle with respect to the direction of the shorter side of the vibration plane, the first portion separating the two sound openings in a direction of a shorter side of the vibration plane.

12. The speaker grille of claim 11, wherein the reinforcement rib further has second portions in the direction of the shorter side of the vibration plane for further splitting each of the two sound openings.

13. The speaker grille of claim 11, further provided with a magnet on a surface of the first portion, the surface opposing to the vibration plane.
